(19) United States
(12) Patent Application Publication
(10) Pub. No.: US 2009/0192797 A1
(43) Pub. Date: Jul. 30, 2009

(54) Talk text

(76) Inventor: Joseph Bambola, Corpus Christi, TX (US)

Correspondence Address: JOSEPH BAMBOLA, 4334 OCEAN DR. SUITE 705, CORPUS CHRISTI, TX, 78412, US

(21) Appl. No.: 12/380,221

(22) Filed: Apr. 6, 2009

Related U.S. Application Data
(60) Provisional application No. 61/201,630, filed on Dec. 12, 2008.

(51) Int. Cl. G10L 15/26

(52) U.S. Cl. 704/235; 704/E15.043

(57) ABSTRACT

The patent that I am requesting is for an existing product on the market. It is for voice transponding or activated texting. Rather than typing a text message, the user can simply speak into their cell phone and the message will be typed into the text message.

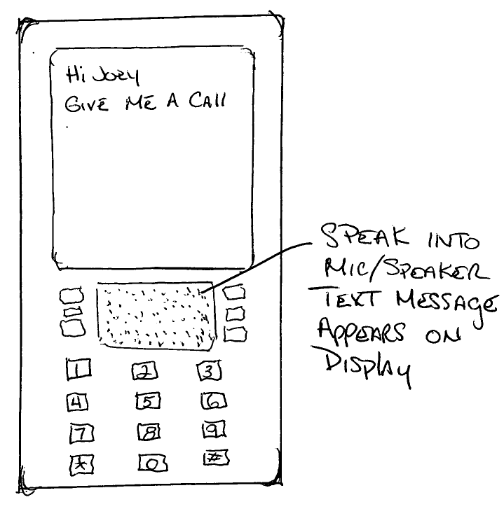

The drawing page illustrates a cell phone drawing with the capability to accept voice transcribing or activated text.

The built in microphone and software enabling the voice text will appear on the LCD screen. The user can then send the message.

1. This invention will allow cell phone users who like to text, to speak into their phones and the text message to be sent, will appear on the screen. Rather than typing a text message, a voice activated typing software will enable users to text, virtually hands free.
